(19) United States
(12) Patent Application Publication
(10) Pub. No.: US 2025/0139537 A1
(43) Pub. Date: May 1, 2025

(54) SYSTEM, TERMINAL, CONTROL METHOD OF TERMINAL, AND STORAGE MEDIUM

(71) Applicant: NEC Corporation, Minato-ku, Tokyo (JP)

(72) Inventors: Fumiya IGARASHI, Tokyo (JP); Haruka SATO, Tokyo (JP); Tomohiro YAMAGUCHI, Tokyo (JP); Yusuke MIYAMOTO, Tokyo (JP); Saki KATO, Tokyo (JP)

(73) Assignee: NEC Corporation, Minato-ku, Tokyo (JP)

(21) Appl. No.: 18/836,410

(22) PCT Filed: Mar. 1, 2022
(86) PCT No.: PCT/JP2022/008614

§ 371 Date: Aug. 7, 2024

(51) Int. Cl. G06Q 10/02; G06Q 50/12

(52) U.S. Cl. CPC G06Q 10/02; G06Q 50/12

(57) ABSTRACT

A system includes a hotel server managed by a hotel, and a terminal possessed by a user. The terminal includes a storage unit and an advance check-in control unit. The storage unit stores reservation information of the hotel including a start date of stay and reservation holder identifying information that identifies a reservation holder of the hotel in association with each other. The advance check-in control unit asks the user to agree to provide the reservation holder identifying information to the hotel server a predetermined period before the start date of stay. When the user agrees to provide the reservation holder identifying information, the advance check-in control unit transmits the reservation holder identifying information to the hotel server as hotel guest identifying information that identifies a hotel guest staying at the hotel.

### TECHNICAL FIELD

The present invention relates to a system, a terminal, a control method of a terminal, and a storage medium.

### BACKGROUND ART

There exists technology related to hotel check-in.

For example, Patent Literature 1 describes that a check-in of a user to an accommodation facility and use of services are properly managed. An accommodation facility management system includes a first acquisition means, an execution means, a second acquisition means, and a permission means. The first acquisition means acquires a face image of a visiting user who uses a check-in terminal installed at a position visible from a reception counter of the accommodation facility. The execution means identifies the visiting user based on the face image of the visiting user and executes a check-in process for the visiting user. The second acquisition means acquires a face image of a specified user who uses the service. The permission means permits the use of the service when the check-in process of the specified user identified based on the face image of the specified user has been completed.

### CITATION LIST

### Patent Literature

[PTL 1] Japanese Unexamined Patent Application Publication No. JP2021-068371

### SUMMARY OF INVENTION

### Technical Problem

As disclosed in Patent Literature 1, a check-in procedure is performed using biometric authentication. However, even when the check-in procedure is performed using biometric authentication, a hotel (accommodation business operator) is still required to create a lodging registration card (registration card) for a hotel guest. Therefore, even if a user checks in using biometric authentication, the user needs to submit the lodging registration card describing his or her name, and so on, to the hotel where the user will stay.

As described above, even if the check-in procedure is performed using biometric authentication, the user still needs to create the lodging registration card, which reduces convenience for the user.

It is a main object of the present invention to provide a system, a terminal, a control method of a terminal, and a storage medium, which contribute to improving convenience for users staying at hotels.

### Solution to Problem

According to a first aspect of the present invention, there is provided a system, including: a hotel server managed by a hotel; and a terminal possessed by a user, wherein the system terminal further includes: a storage unit that stores reservation information of the hotel including a start date of stay and reservation holder identifying information that identifies a reservation holder of the hotel in association with each other; and an advance check-in control unit that asks the user to agree to provide the reservation holder identifying information to the hotel server a predetermined period before the start date of stay, and transmits the reservation holder identifying information to the hotel server as hotel guest identifying information that identifies a hotel guest staying at the hotel when the user agrees to provide the reservation holder identifying information.

According to a second aspect of the present invention, there is provided a terminal, including: a storage unit that stores reservation information of a hotel including a start date of stay and reservation holder identifying information that identifies a reservation holder of the hotel in association with each other; and an advance check-in control unit that asks the user to agree to provide the reservation holder identifying information to a hotel server a predetermined period before the start date of stay, and transmits the reservation holder identifying information to the hotel server as hotel guest identifying information that identifies a hotel guest staying at the hotel when the user agrees to provide the reservation holder identifying information.

According to a third aspect of the present invention, there is provided a control method of a terminal, the control method including: storing reservation information of a hotel including a start date of stay and reservation holder identifying information that identifies a reservation holder of the hotel in association with each other; and asking the user to agree to provide the reservation holder identifying information to a hotel server a predetermined period before the start date of stay, and transmitting the reservation holder identifying information to the hotel server as hotel guest identifying information that identifies a hotel guest staying at the hotel when the user agrees to provide the reservation holder identifying information.

According to a fourth aspect of the present invention, there is provided a computer-readable storage medium storing a program causing a computer mounted on an authentication terminal to perform processing for: storing reservation information of a hotel including a start date of stay and reservation holder identifying information that identifies a reservation holder of the hotel in association with each other; and asking the user to agree to provide the reservation holder identifying information to a hotel server a predetermined period before the start date of stay, and transmitting the reservation holder identifying information to the hotel server as hotel guest identifying information that identifies a hotel guest staying at the hotel when the user agrees to provide the reservation holder identifying information.

### Advantageous Effects of Invention

The individual aspects of the present invention provide a system, a terminal, a control method of a terminal, and a storage medium, which contribute to improving convenience for users staying at hotels. The advantageous effect of the present invention is not limited to the above advantageous effect. The present invention may provide other advantageous effects, instead of or in addition to the above advantageous effect.

### BRIEF DESCRIPTION OF THE DRAWINGS

FIG. 1 is a diagram illustrating an outline of an example embodiment.

FIG. 2 is a flowchart illustrating an outline of an operation of an example embodiment.

FIG. 3 is a diagram illustrating an example of a schematic configuration of an information processing system according to a first example embodiment.

FIG. 4 is a diagram illustrating an example of a display of a terminal according to the first example embodiment.

FIG. 5 is a diagram illustrating an example of a display of the terminal according to the first example embodiment.

FIG. 6 is a diagram illustrating an example of a display of the terminal according to the first example embodiment.

FIG. 7 is a diagram illustrating an operation of the information processing system according to the first example embodiment.

FIG. 8 is a diagram illustrating an example of a display of the terminal according to the first example embodiment.

FIG. 9 is a diagram illustrating an example of a display of the terminal according to the first example embodiment.

FIG. 10 is a diagram illustrating an operation of the information processing system according to the first example embodiment.

FIG. 11 is a diagram illustrating an operation of the information processing system according to the first example embodiment.

FIG. 12 is a diagram illustrating an example of a display of the terminal according to the first example embodiment.

FIG. 13 is a diagram illustrating an example of a processing configuration of the terminal according to the first example embodiment.

FIG. 14 is a diagram illustrating an example of a reserved hotel management database according to the first example embodiment.

FIG. 15 is a flowchart illustrating an example of an operation of an advance check-in control unit according to the first example embodiment.

FIG. 16 is a diagram illustrating an example of a processing configuration of a hotel server according to the first example embodiment.

FIG. 17 is a diagram illustrating an example of a reservation holder information database according to the first example embodiment.

FIG. 18 is a diagram illustrating an example of a processing configuration of a reservation server according to the first example embodiment.

FIG. 19 is a diagram illustrating an example of a processing configuration of a check-in terminal according to the first example embodiment.

FIG. 20 is a diagram illustrating an example of a display of the check-in terminal according to the first example embodiment.

FIG. 21 is a diagram illustrating an example of a display of the check-in terminal according to the first example embodiment.

FIG. 22 is a diagram illustrating an example of a display of the check-in terminal according to the first example embodiment.

FIG. 23 is a sequence diagram illustrating an example of an operation in the information processing system according to the first example embodiment.

FIG. 24 is a diagram illustrating an example of a hardware configuration of the terminal in the present application.

FIG. 25 is a diagram illustrating an example of a display of the terminal according to a variation of the present application.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

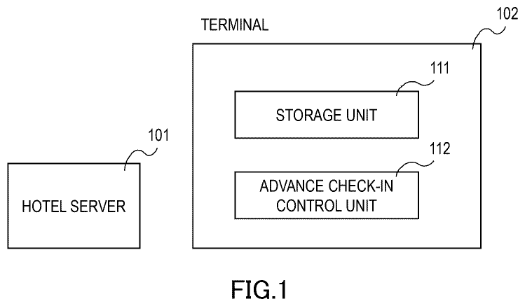

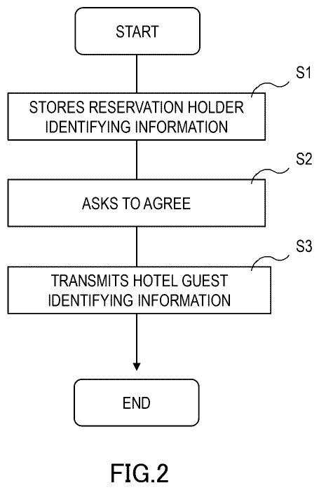

A system according to an example embodiment includes a hotel server 101 managed by a hotel, and a terminal 102 possessed by a user (see FIG. 1). The terminal 102 includes a storage unit 111 and an advance check-in control unit 112. The storage unit 111 stores reservation information of the hotel including a start date of stay and reservation holder identifying information that identifies a reservation holder of the hotel in association with each other (step S1 in FIG. 2). The advance check-in control unit 112 asks the user to agree to provide the reservation holder identifying information to the hotel server 101 a predetermined period before the start date of stay (step S2). When the user agrees to provide the reservation holder identifying information, the advance check-in control unit 112 transmits the reservation holder identifying information to the hotel server 101 as hotel guest identifying information that identifies a hotel guest staying at the hotel (step S3).

The terminal 102 stores and manages a reservation of a hotel, in particular, a plurality of reservations of hotels (reservation information). The management of the reservation of the hotel is performed using a hotel management application, which will be described below. The terminal 102 (the hotel management application) prompts a user to complete an “advance check-in procedure” a predetermined number of days before the start date of stay at a reserved hotel (check-in date). Specifically, the terminal 102 asks the user to confirm that information on a hotel guest staying at the reserved hotel is correct for him or her own information, and also asks the user to agree to provide the information of the hotel guest to the hotel where he or she will stay. When the user gives consent, the terminal 102 transmits hotel guest identifying information to the hotel server 101. When the reservation holder identifying information that identifies the reservation holder and the hotel guest identifying information transmitted in the advance check-in procedure match, the hotel server 101 sets a status of the reservation holder to “lodging registration completed (advance check-in completed)”. The reservation holder can stay at the hotel without making a lodging registration card at the hotel. As a result, convenience for users staying at the hotel guest is improved.

Hereinafter, specific example embodiments will be described in more detail with reference to drawings.

### First Example Embodiment

A first example embodiment will be described in more detail with reference to drawings.

### [System Configuration]

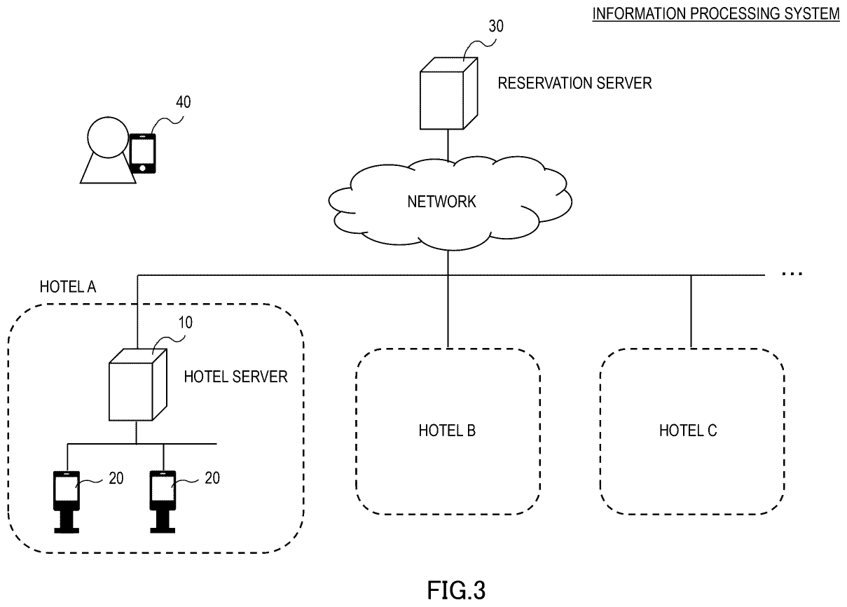

FIG. 3 is a diagram illustrating an example of a schematic configuration of an information processing system according to a first example embodiment. As shown in FIG. 3, the information processing system includes a plurality of hotels (accommodation business operators).

Each hotel included in the information processing system may be operated by the same business operator or by different business operators. In other words, each hotel may be in the same chain of hotels by the same business operator, or each hotel may be in a different chain of hotels by different business operators.

Each hotel shown in FIG. 3 supports at least one of biometric authentication and code authentication. Note that code authentication is an authentication method in which a code such as a two-dimensional bar code is displayed on a terminal, and a user is authenticated using the displayed code on the terminal.

By performing a check-in procedure using these biometric and/or code authentication, the user can use the hotel without performing the procedure face to face with an employee of the hotel. In the present application, such a check-in procedure that does not require to perform the procedure face to face is referred to as “smooth check-in”.

Each hotel includes a hotel server 10 that manages reservation information (for example, duration of stay) or the like of reservation holders, and a check-in terminal 20 that is used by users to perform the smooth check-in procedure. Note that the hotel server 10 and check-in terminal 20 included by Hotel B and Hotel C are omitted in FIG. 3.

The hotel server 10 is managed by a corresponding hotel. The hotel server 10 may be installed in the hotel or on a network (on a cloud). The check-in terminal 20 is installed in a lobby or the like of each hotel.

A reservation server 30 is a server that makes a reservation for a hotel. The reservation server 30 is managed and operated by a travel agency or a business operator that provides a service related to online reservations for a reservation. The reservation server 30 may be installed in a building of the travel agency, and so on, or the reservation server 30 may be installed on a network (on a cloud).

A user can make a reservation for a hotel via the reservation server 30, or directly by accessing the WEB (web) site of the desired hotel.

The user possesses a terminal 40. The user makes a reservation, or the like, for a hotel using the terminal 40. In addition, the user displays a two-dimensional barcode by operating the terminal 40 when the user performs code authentication using the two-dimensional barcode or the like. The terminal 40 is, for example, a mobile terminal such as a smartphone, tablet, and so on.

The configuration of the information processing system shown in FIG. 3 is an example and is not intended to limit the configuration of the authentication system. For example, a plurality of reservation servers 30 may be included in the system. In addition, while three hotels (accommodation business operators) are illustrated in FIG. 3, the number of hotels included in the system is not of course limited to any particular number.

### [Outline of Operation]

Next, a schematic operation of the information processing system according to the first example embodiment will be described.

### <Installation of Application>

First, a user installs a “hotel management application” on the terminal 40. The user acquires the hotel management application by any means and installs the hotel management application on the terminal 40. For example, the user accesses a web page provided by the reservation server 30 or the hotel server 10 by operating the terminal 40, and acquires the hotel management application from the web page.

### <Initial Registration>

First, a user launches the hotel management application and registers his or her personal information (for example, name, date of birth, gender, address, and so on) and biometric information with the hotel management application.

Note that examples of the biometric information include data (feature values) calculated from physical features unique to an individual, such as a face, a fingerprint, a voiceprint, a vein, a retina, or an iris pattern of an eye. Alternatively, the biometric information may be image data such as a face image, a fingerprint image, and so on. The biometric information may be anything that includes physical characteristics of a user as information. In the present application, a case in which biometric information about a “face” of a person (a face image or a feature value generated from the face image) is used will be described.

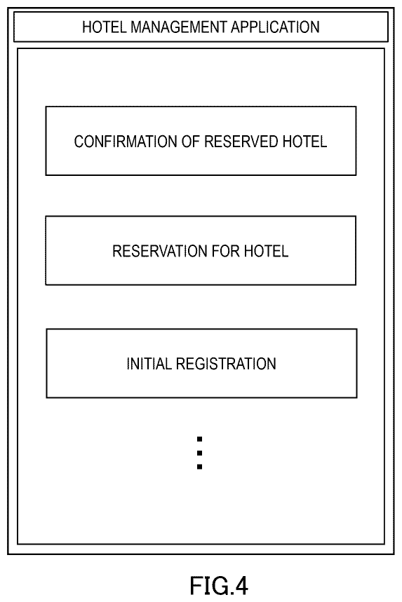

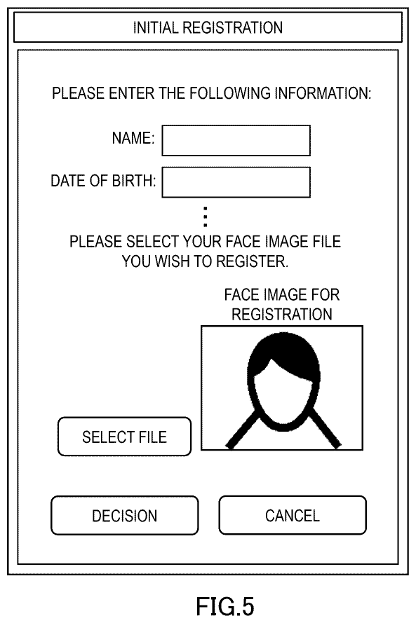

When the hotel management application is launched, the menu screen as shown in FIG. 4 is displayed on the terminal 40. When the user uses the hotel management application for the first time, the user presses an “initial registration” button. In response to pressing the button, the terminal 40 displays a GUI (Graphical User Interface) as shown in FIG. 5, and acquires personal information (name, and the like) and biometric information (face image).

Note that in addition to name, gender, and so on, examples of the personal information that can be registered when initially registering for the hotel management application include contact information (e-mail address that can be received by the terminal 40), account information (credit card information, and so on), and so on.

Furthermore, among the personal information that is initially registered, information that identifies the user is described as “user identifying information”. For example, examples of the user identifying information include a combination of name, gender, date of birth and address. Alternatively, the user identifying information may be the name or a combination of name and date of birth.

The hotel management application (the terminal 40) stores the acquired personal information and biometric information. Moreover, the terminal 40 stores a terminal ID to be used for code authentication.

### <Reservation for Hotel>

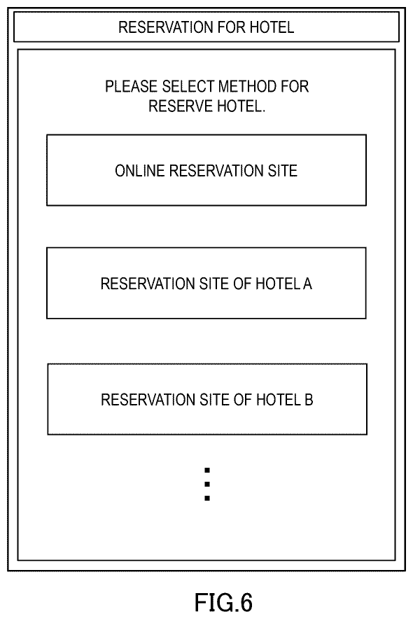

The user who has completed the initial registration can make a reservation for a hotel. In this case, the user operates the terminal 40 and presses the “hotel reservation” button on the menu screen shown in FIG. 4. In response to pressing the button, the terminal 40 displays a GUI as shown in FIG. 6.

As shown in FIG. 6, the terminal 40 displays a button corresponding to a link posted on an online reservation site that specializes in a reservation of a hotel, a button corresponding to a link posted on a reservation site for an individual hotel, and so on. For example, when the user has not specifically decided which hotel to make a reservation, the user makes the reservation for the hotel at the online reservation site, and when the user has decided which hotel to make the reservation, the user makes the reservation from the reservation site of the desired hotel.

When the user presses the button (the link posted on the reservation site), the terminal 40 accesses the server where the link leads to. For example, when “online reservation site” is pressed, the terminal 40 accesses the reservation server 30. When “reservation site of Hotel A” is pressed, the terminal 40 accesses the hotel server 10 of Hotel A.

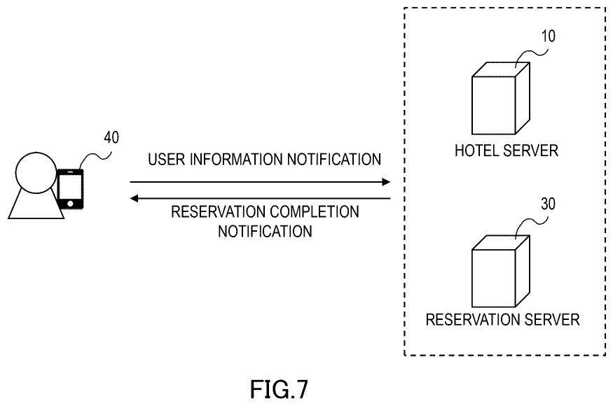

At that time, the hotel management application (the terminal 40) transmits the user identifying information (for example, name, date of birth, and so on) and authentication information acquired by the initial registration to the server to be accessed. Specifically, the terminal 40 transmits a “user information notification” to the server to be accessed, which includes the user identifying information and the authentication information (see FIG. 7). The authentication information corresponds to biometric information such as a face image of the user or a terminal ID.

The user makes a reservation for a hotel on the server (the reservation server 30 or the hotel server 10) where the link leads to. Note that a detailed description of making the reservation for the hotel is omitted. The hotel server 10 and the reservation server 30 provide the user with information such as room availability and price. The user decides which hotel to make the reservation, by taking into consideration location of the hotel, purpose of stay, grade of guest room, and so on. Furthermore, the hotel server 10 and the reservation server 30 provide information on an authentication method (biometric authentication, code authentication) that can be used for the smooth check-in at each hotel. For example, the hotel server 10 provides the user who selects a hotel with information such as “check-in is possible using biometric authentication”, “check-in is possible using code authentication”, or “check-in is possible using either biometric authentication or code authentication” as the authentication method that can be used at own hotel.

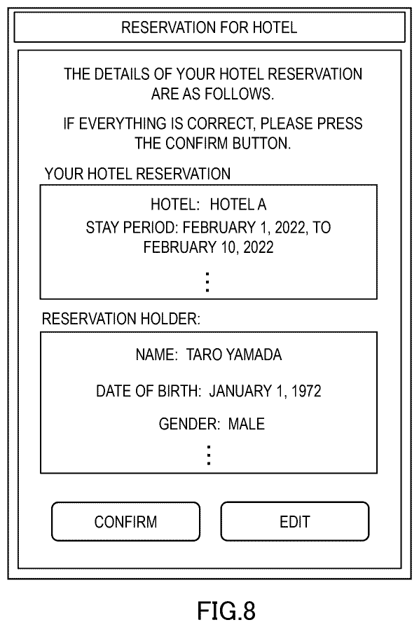

The hotel server 10 or the reservation server 30 displays information selected by the user (see FIG. 8). The hotel server 10 or the reservation server 30 completes a reservation made by the user when the “confirm” button shown in FIG. 8 is pressed.

When the reservation for the hotel is completed, the hotel server 10 or the reservation server 30 transmits a reservation completion notification to the terminal 40 (see FIG. 7).

The reservation completion notification includes a reservation number identifying the reservation for the hotel, information identifying a reservation holder, reservation information (for example, the name of the hotel to stay, length of stay, and room grade), and information on the reserved hotel.

In the following description, information that identifies the reservation holder will be described as reservation holder identifying information. For example, examples of the reservation holder identifying information include a combination of name, gender, date of birth and address. Alternatively, the reservation holder identifying information may be the name or a combination of name and date of birth. When a user who possesses the terminal 40 makes a reservation for a hotel to stay for himself/herself, the user identifying information and the reservation holder identifying information match. On the other hand, when the user of the terminal 40 makes the reservation for the hotel where a family member or the like will stay, the user identifying information and the reservation holder identifying information are different.

Furthermore, in the following description, information on a reserved hotel will be described as “reserved hotel information”. The reserved hotel information includes information such as a name, an address, an access method, contact information, a photo of the hotel (icon), a home page URL (Uniform Resource Locator), and an authentication method to use the smooth check-in of the hotel.

The hotel management application (the terminal 40) stores contents of the received reservation completion notification in a database. The hotel management application stores information included in the reservation completion notification in a reserved hotel management database. Details of the reserved hotel management database will be described below.

In addition, when the hotel server 10 completes the reservation for the hotel made by the user, the hotel server 10 stores the reservation number, reservation holder identifying information, authentication information, reservation information, and so on in the reservation holder information database. Details of the reservation holder information database will be described below.

Here, when the user makes the reservation for the hotel via the reservation server 30, the reservation server 30 transmits the user information notification received from the terminal 40 and the reservation completion notification transmitted to the terminal 40 of the user to the hotel where the user will stay (the hotel server 10).

When the hotel server 10 receives the user information notification and the reservation completion notification from the reservation server 30, the hotel server 10 stores the reservation number, reservation holder identifying information, authentication information, reservation information, and so on in the reservation holder information database just as when the user directly makes a reservation.

### <Advance Check-In>

In order to complete a check-in procedure without meeting an employee of a hotel, or the like (in order to use the smooth check-in), a user is required to complete an advance check-in procedure.

Specifically, the user is required to submit information necessary for the hotel (accommodation business operator) to create a lodging registration card (registration card) to the hotel where the user will stay in advance. Providing the information is required to be completed a predetermined number of days before a start of stay (for example, three days before the start of stay).

The hotel management application periodically accesses the reserved hotel management database and identifies a reservation (an entry in the reserved hotel management database) for which start date of stay at the hotel reserved by the user will arrive after a predetermined date. The hotel management application prompts the user to check in in advance to use the hotel using the smooth check-in with respect to the identified reservation for the hotel. For example, the hotel management application prompts the user to complete the advance check-in procedure three days before the start date of stay.

At that time, the hotel management application (terminal 40) determines whether the user identifying information registered in advance by the user matches the reservation holder identifying information for the reservation that is the subject of the above advance check-in.

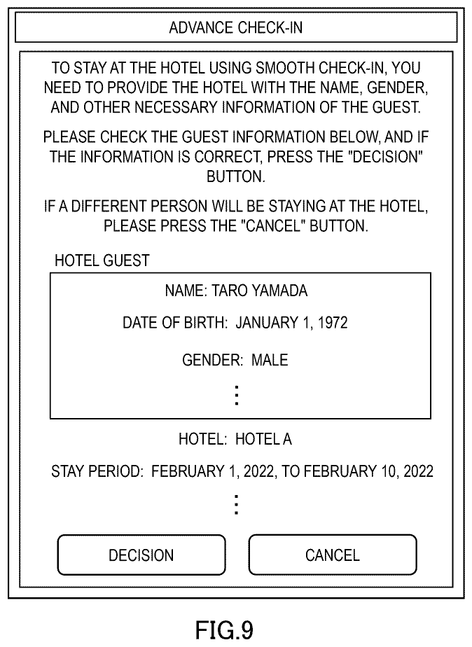

When the two pieces of identifying information match, the hotel management application displays a GUI, for example, as shown in FIG. 9. As shown in FIG. 9, the terminal 40 notifies the user that information identifying a hotel guest needs to be submitted to the hotel where the hotel guest will stay in order to use the smooth check-in. Note that, as shown in FIG. 9, when the hotel management application prompts the user to complete the advance check-in procedure, it is desirable to display the name of the hotel where the advance check-in is available and the duration of stay.

In the following description, information that identifies a hotel guest is described as hotel guest identifying information. For example, examples of the hotel guest identifying information include a combination of name, gender, date of birth and address. Alternatively, the hotel guest identifying information may be the name, or a combination of name and date of birth. When a user who possesses the terminal 40 stays at a hotel for himself/herself, the user identifying information, the reservation holder identifying information, and the hotel guest identifying information match.

As shown in FIG. 9, the terminal 40 displays the user identifying information (or the reservation holder identifying information) that has been registered in advance as the hotel guest identifying information, and asks the user to confirm that the user who possesses the terminal 40 is the hotel guest. When the possessor of the terminal 40 stays at the hotel, the name, and so on, of the user himself/herself is displayed, and the user presses the “confirm” button as shown in FIG. 9. On the other hand, when a person different from the possessor (owner) of the terminal 40 stays at the hotel, the user presses the “cancel” button.

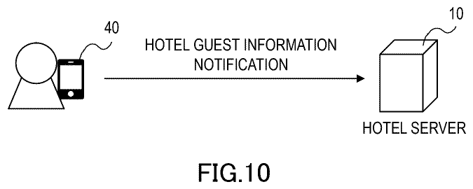

When the user agrees to provide the hotel guest identifying information displayed on the terminal 40 to the hotel where the user will stay (when the Decision button is pressed), the terminal 40 transmits a “hotel guest information notification” to the hotel server 10 of the hotel where the user will stay, which includes the reservation number, hotel guest identifying information, and so on (see FIG. 10).

When the terminal 40 transmits the hotel guest information notification, the terminal 40 determines that the advance check-in for the corresponding reservation has been completed. The terminal 40 sets “advance check-in completed” in the status field of the corresponding reservation (an entry in the database).

When the user does not agree to provide the hotel guest identifying information displayed on the terminal 40 to the hotel where the user will stay (when the Cancel button is pressed), the terminal 40 does not take any special action. In this case, even if the user who has made the reservation for the hotel visits the hotel where the user will stay, the user will not be able to use the smooth check-in. This is because the advance check-in (pre-check-in) has not been completed.

The hotel server 10 identifies the corresponding reservation based on the reservation number included in the reserved hotel information notification. The hotel server 10 compares the reservation holder identifying information of the identified reservation with the hotel guest identifying information received from the terminal 40, and when the two pieces of identifying information match, the hotel server 10 treats the advance check-in of the reservation holder (person who plans to stay at the hotel) as completed.

The hotel server 10 stores the fact that the advance check-in has been completed in the reservation holder information database. The hotel server 10 sets the status of the reservation holder to “advance check-in completed” and stores the status in association with the reservation holder identifying information (name, date of birth, and so on), the authentication information, the reservation information, and so on.

### <Check-In >

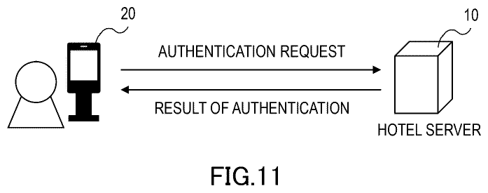

When the user arrives at the hotel on the day the stay begins, the user moves in front of the check-in terminal 20 installed at the lobby or the like (see FIG. 11). When the check-in terminal 20 detects the user in front of the check-in terminal 20, the check-in terminal 20 requests the user to provide the authentication information (biometric information or the terminal ID).

When the hotel supports biometric authentication, the check-in terminal 20 acquires biometric information (face image) of the user in front of the check-in terminal 20. When the hotel supports code authentication, the check-in terminal 20 reads a two-dimensional bar code, or the like, whose terminal ID has been converted from the terminal 40 possessed by the user in front of the check-in terminal 20.

The check-in terminal 20 transmits an authentication request that includes the acquired authentication information (the biometric information, terminal ID) to the hotel server 10.

The hotel server 10 uses the authentication information included in the authentication request and identifies the reservation holder registered in the reservation holder information database. When the status of the identified reservation holder is “advance check-in completed”, the hotel server 10 treats the check-in procedure of the reservation holder as successful.

In this case, the hotel server 10 transmits a positive response indicating check-in success (authentication success) to the check-in terminal 20. At that time, the hotel server 10 sets the status of the reservation holder to “checked in” and also notifies the check-in terminal 20 with the number of a guest room and so on.

When the check-in terminal 20 receives the positive response (authentication success, check-in success), the check-in terminal 20 notifies the user that the check-in procedure has been successfully completed, along with information on the guest room. At that time, the check-in terminal 20 notifies the user that the user can go directly to the guest room.

In this way, the user who has completed the advance check-in can complete the check-in procedure without coming into contact with a staff member, or the like of the hotel, and so on by being authenticated using biometric authentication or a code at the check-in terminal 20. In other words, the user can use the reserved hotel using the smooth check-in.

### <Confirmation of Reserved Hotel>

The user can use the hotel management application to check the status of reserved hotels. In this case, the user clicks the “confirm reserved hotel” button on the menu screen shown in FIG. 4.

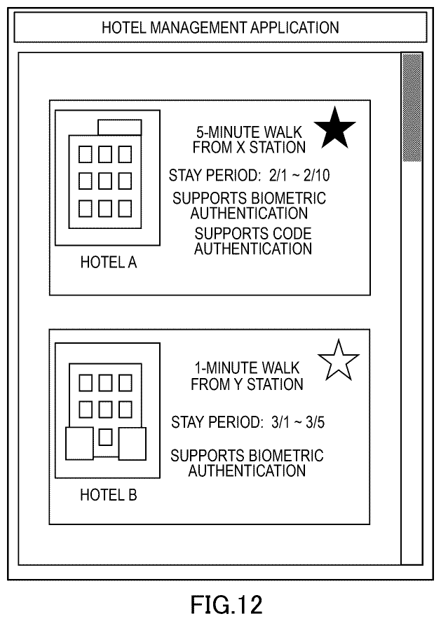

In response to pressing the “confirm reserved hotel” button, the terminal 40 performs the display as shown in FIG. 12. The terminal 40 displays information on each reserved hotel registered in the reserved hotel management database. For example, the terminal 40 displays a list of the information of the reserved hotels as shown in FIG. 12.

For example, the terminal 40 displays detailed information about each hotel (name, address, authentication method for using the smooth check-in, and so on, of the hotel), information about the reservation of the hotel (for example, duration of stay), and a status of the advance check-in.

Note that in FIG. 12, the status of the advance check-in is represented by a color applied to a star-shaped figure. Specifically, a black star is displayed for the hotel for which the advance check-in has been completed, and a white star is displayed for the hotel for which the advance check-in has not been completed.

The user can confirm information on the reserved hotel and information on the advance check-in by the display as shown in FIG. 12. Next, details of the individual apparatuses included in the information processing system according to the first example embodiment will be described.

### [Terminal]

Examples of the terminal 40 include a mobile terminal device such as a smartphone, a mobile phone, a game console, a tablet, and so on. The terminal 40 can be any equipment or device as long as the terminal 40 can accept an operation by a user and can communicate with the hotel server 10, the reservation server 30, and so on.

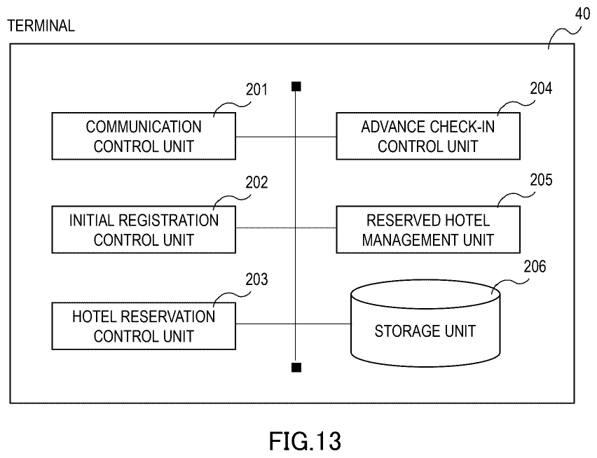

FIG. 13 is a diagram illustrating an example of a processing configuration (processing modules) of the terminal 40 according to the first example embodiment. Referring to FIG. 13, the terminal 40 includes a communication control unit 201, an initial registration control unit 202, a hotel reservation control unit 203, an advance check-in control unit 204, a reserved hotel management unit 205, and a storage unit 206.

The communication control unit 201 is means for controlling communication with other apparatuses. For example, the communication control unit 201 receives data (packets) from the hotel server 10. In addition, the communication control unit 201 transmits data to the hotel server 10. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The initial registration control unit 202, the hotel reservation control unit 203, the advance check-in control unit 204, and the reserved hotel management unit 205 are realized by the hotel management application installed in the terminal 40. A detailed description of the installation of the hotel management application will be omitted. This is because the installation of the application is obvious to those skilled in the art and is not the intent of the present application.

The initial registration control unit 202 is means for performing control related to the initial registration when a user uses the hotel management application. When the “initial registration” button is pressed on the menu screen of the hotel management application, the initial registration control unit 202 displays a GUI as shown in FIG. 5, and acquires personal information (user identifying information), biometric information acquisition, or the like, of the user.

The initial registration control unit 202 stores the acquired information in the storage unit 206.

The hotel reservation control unit 203 is means for performing control related to a reservation of a hotel. The hotel reservation control unit 203 displays a GUI as shown in FIG. 6 when the “hotel reservation” button is pressed on the menu screen of the hotel management application.

The hotel reservation control unit 203 accesses the reservation site selected by the user. For example, in the example of FIG. 6, when the user selects “online reservation site”, the hotel reservation control unit 203 accesses the reservation server 30. Alternatively, when the user selects “reservation site of Hotel A”, the hotel reservation control unit 203 accesses the hotel server 10 of Hotel A.

At that time, the hotel reservation control unit 203 transmits a user information notification including user identification information (name, date of birth, and so on) and authentication information (face image used for biometric authentication, terminal ID used for code authentication) stored in the storage unit 206 to the server to be accessed.

The hotel reservation control unit 203 selects the hotel, and so on, to be made a reservation in accordance with a GUI provided by the server to be accessed and an operation by a user. In other words, the hotel reservation control unit 203 determines the hotel where the user will stay and the duration of stay, and so on, in accordance with the operation by the user, and inputs these information to the server to be accessed. Once the hotel to be made a reservation is determined, the server to be accessed displays a GUI as shown in FIG. 8. When the user presses the “confirm” button in FIG. 8, the server to be accessed transmits a reservation completion notification.

The hotel reservation control unit 203 receives the reservation completion notification.

Note that in FIG. 8, when a person different from the user (the user operating the terminal 40) is to stay at the hotel, the user presses the “edit” button. In addition, the user inputs information identifying the person who is to stay at the reserved hotel (reservation holder identifying information; name, date of birth, and so on) in accordance with instructions from the server to be accessed, and so on.

When the information of the correct reservation holder (person who plans to stay at the hotel) is input, the information on “reservation holder” shown in FIG. 8 is updated, and the user presses the “confirm” button. In this case as well, the hotel reservation control unit 203 receives the above reservation completion notification.

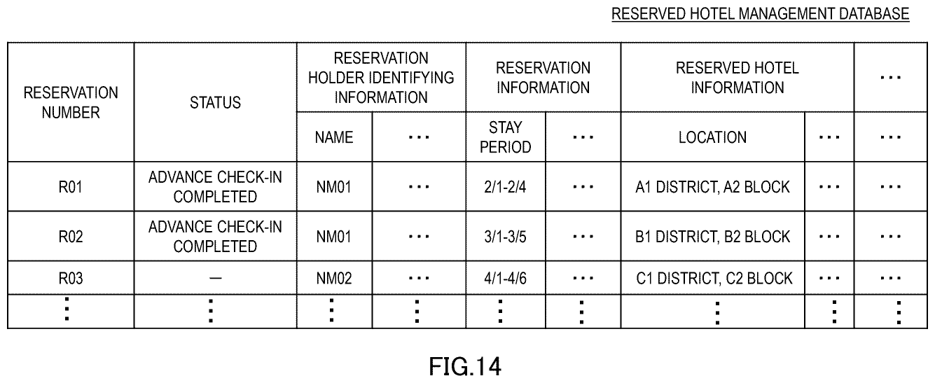

The reservation completion notification includes the reservation number, the reservation holder identifying information, the reservation information, and the reserved hotel information, and so on. The hotel reservation control unit 203 stores this information in the reserved hotel management database (see FIG. 14). Note that the reserved hotel management database shown in FIG. 14 is an example, and is not intended to limit the items to be stored.

The advance check-in control unit 204 is means for performing control related to the advance check-in to use the smooth check-in. The advance check-in control unit 204 asks the user to agree to provide the reservation holder identifying information to the hotel server 10 a predetermined period before the start date of stay (a predetermined number of days before). When the user agrees to provide the reservation holder identifying information, the advance check-in control unit 204 transmits the reservation holder identifying information to the hotel server 10 as hotel guest identifying information that identifies the hotel guest who will stay at the hotel.

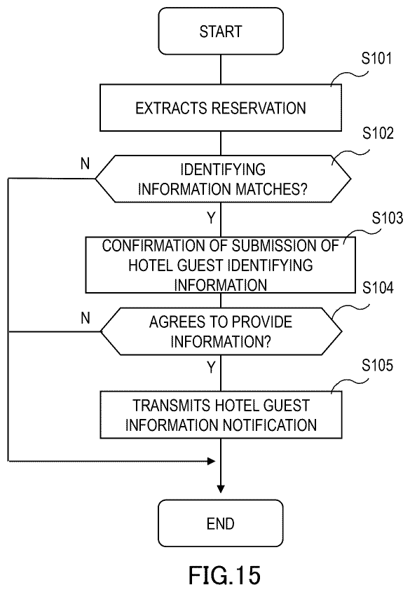

Referring to FIG. 15, the operation of the advance check-in control unit 204 will be described in more detail.

The advance check-in control unit 204 accesses the reserved hotel management database periodically or at a predetermined timing and extracts a reservation (entry) whose start date of stay comes after a predetermined number of days (extract reservation; step S101).

The advance check-in control unit 204 determines whether the reservation holder identifying information of the extracted reservation and the user identification information stored in the storage unit 206 match (step S102).

When the two pieces of identifying information match (step S102, Yes branch), the user (possessor of the terminal 40) is determined to be ready for the advance check-in procedure, so the advance check-in control unit 204 displays a GUI as shown in FIG. 9. The advance check-in control unit 204 displays the GUI shown in FIG. 9 to acquire whether or not the user agrees to submit the hotel guest identifying information to the hotel where the user will stay (confirmation of submission of hotel guest identifying information; step S103).

When the user agrees to provide the information (step S104, Yes branch), the advance check-in control unit 204 transmits a hotel guest information notification including the reservation number of the corresponding reservation and the hotel guest identifying information that identify the hotel guest to the hotel server 10 where the user will stay (step S105). That is, when the user himself/herself stays at the reserved hotel, the hotel guest information notification is transmitted to the hotel server 10.

Note that when the advance check-in control unit 204 transmits the hotel guest information notification to the hotel server 10, the advance check-in control unit 204 reflects this fact in the reserved hotel management database. Specifically, the advance check-in control unit 204 stores “advance check-in completed” in the status field of the reserved hotel management database.

When the user refuses to provide the hotel guest identifying information (step S104, No branch; when the cancel button shown in FIG. 9 is pressed), the advance check-in control unit 204 does not take any special action. Alternatively, the advance check-in control unit 204 may notify the user that the user will be required to follow a normal check-in procedure at the hotel (that the smooth check-in is not available) because the user has refused to provide the hotel guest identifying information.

When the user identification information and the reservation holder identifying information do not match (step S102, No branch), the advance check-in control unit 204 does not take any special action. Alternatively, the advance check-in control unit 204 notifies the user that the start date of the extracted reservation is approaching.

Note that in this case, since other person who is not the user of the terminal 40 (possessor of the terminal 40) stays at the reserved hotel, the other person cannot use the smooth check-in at the reserved hotel. This is because the reserved hotel does not retain the authentication information (biometric information, terminal ID) of the other person. This situation can occur when a user makes a reservation for a hotel where a family member will stay for the family member, or the like. When the user is notified by the terminal 40 that the start date to stay at the hotel is approaching, the user may notify the hotel guests (for example, a family member) of this fact.

In this way, the advance check-in control unit 204 asks the user to agree to provide the reservation holder identifying information to the hotel server 10 as hotel guest identifying information when the user identifying information stored in the storage unit 206 and the reservation holder identifying information match.

The reserved hotel management unit 205 is means for displaying information related to a reservation of a hotel. More specifically, the reserved hotel management unit 205 manages information related to the reserved hotel for which a user has completed the reservation procedure. When the “confirm reserved hotel” button is pressed on the menu screen of the hotel management application, the reserved hotel management unit 205 displays information as shown in FIG. 12.

The reserved hotel management unit 205 generates information indicating reservation status of the hotel from each entry in the reserved hotel management database and displays the information in a list format, for example, as shown in FIG. 12.

More specifically, the reserved hotel management unit 205 acquires information related to a photo of exterior appearance of the hotel, name of the hotel, authentication method for the smooth check-in, and so on, from the reserved hotel information in the reserved hotel management database. Furthermore, the reserved hotel management unit 205 acquires the status of the advance check-in for each reservation based on a setting value in the status field.

The reserved hotel management unit 205 uses these acquired information to generate and display the display shown in FIG. 12. Note that in FIG. 12, the status of the advance check-in is represented by a color applied to a star-shaped figure, but of course the status of the advance check-in may be represented in other ways. For example, the words “advance check-in completed” or “advance check-in not yet completed” or symbols such as a circle or a triangle may be used to indicate the status of the advance check-in.

In this way, the reserved hotel management unit 205 may display the status of the advance check-in when the reserved hotel management unit 205 displays information related to a reservation of a hotel. At that time, reserved hotel management unit 205 may display the status of the advance check-in by changing the color of the figure.

The reserved hotel management unit 205 may manage the reserved hotel management database. Specifically, the reserved hotel management unit 205 accesses the reserved hotel management database periodically or at a predetermined timing and deletes an entry whose stay period has expired.

The storage unit 206 is means for storing information necessary for the operation of the terminal 40. The storage unit 206 stores the reserved hotel information that includes the start date of stay and the reservation holder identifying information that identifies the reservation holder of the hotel in association with each other. Furthermore, the storage unit 206 stores the status of the advance check-in (whether the advance check-in has been completed or not) corresponding to the reservation for which the hotel guest identifying information has been transmitted.

Note that a description of processing modules, and so on, related to the display of the authentication information (authentication code; terminal ID) required for the check-in procedure by the terminal 40 in response to an operation by the user will be omitted. The terminal 40 only needs to be able to convert the terminal ID stored internally into a two-dimensional barcode and display the two-dimensional barcode in response to the operation by the user.

### [Hotel Server]

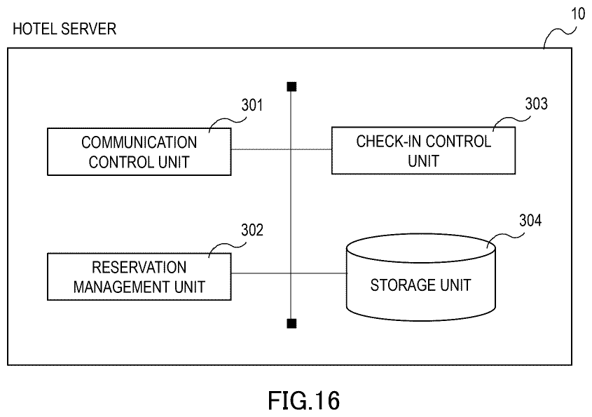

FIG. 16 is a diagram illustrating an example of a processing configuration (processing module) of the hotel server 10 according to the first example embodiment. Referring to FIG. 16, the hotel server 10 includes a communication control unit 301, a reservation management unit 302, a check-in control unit 303, and a storage unit 304.

The communication control unit 301 is means for controlling communication with other apparatuses. For example, the communication control unit 301 receives data (packets) from the terminal 40. In addition, the communication control unit 301 transmits data to the terminal 40. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The reservation management unit 302 is means for managing a reservation of a hotel (guest room) by a user. The reservation management unit 302 receives a “user information notification” from the terminal 40 of the user. In response to receiving the user information notification, the reservation management unit 302 displays a GUI on the terminal 40 for the user to select the duration of stay, guest room, and so on.

When the user has finished making his or her selection, the reservation management unit 302 displays a GUI as shown in FIG. 8 on the terminal 40 as a final confirmation screen of the details of the reservation. Note that the reservation management unit 302 acquires information such as the name of the reservation holder (the person who plans to stay at the hotel) shown in FIG. 8 from the user identifying information included in the user information notification.

When the user (possessor of the terminal 40) does not stay at the hotel for himself/herself, but makes a reservation on behalf of another person to stay at the hotel, the user (possessor of the terminal 40) presses the “edit” button shown in FIG. 8. The reservation management unit 302 acquires information on the person who actually plans to stay at the hotel in response to pressing the “edit” button.

When the reservation management unit 302 acquires the information on the user who actually plans to stay at the hotel, the reservation management unit 302 updates information on the “reservation holder” shown in FIG. 8. After the user confirms the updated information, the user presses the “confirm” button.

When the user presses the “confirm” button, the reservation management unit 302 transmits a reservation completion notification to the terminal 40. Specifically, the reservation management unit 302 transmits the reservation completion notification that includes the reservation number that identifies the completed reservation, the reservation holder identifying information (name, date of birth of the person who plans to stay at the hotel, and so on), the reservation information (duration of stay, and so on), and the reserved hotel information name of the hotel, and so on) to the terminal 40.

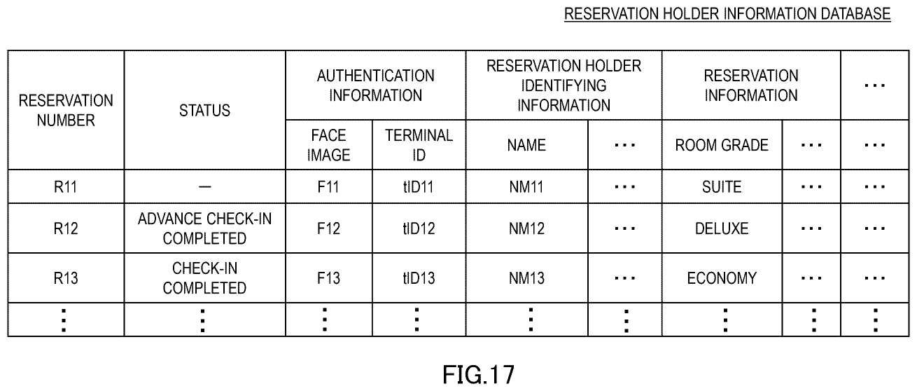

After the reservation management unit 302 transmits the reservation completion notification to the terminal 40, the reservation management unit 302 stores the reservation number, the authentication information (face image, terminal ID), the reservation holder identifying information, the reservation information, and so on in the reservation holder information database (see FIG. 17). Note that the reservation holder information database shown in FIG. 17 is an example, and is not intended to limit items to be stored. For example, information such as the date of the reservation may be registered in the reservation holder information database.

When the reservation management unit 302 acquires the user information notification and the reservation completion notification from the reservation server 30, the reservation management unit 302 stores the authentication information, the reservation holder identifying information, and so on included in these notifications in the reservation holder information database.

The check-in control unit 303 is means for controlling a check-in of the reservation holder. The check-in control unit 303 processes a “hotel guest information notification” received from the terminal 40 and an “authentication request” received from the check-in terminal 20.

When the check-in control unit 303 receives the hotel guest information notification, the check-in control unit 303 searches the reservation holder information database using the reservation number included in the reservation holder information notification as a key, and identifies the corresponding entry. The check-in control unit 303 determines whether the reservation holder identifying information of the identified entry matches the hotel guest identifying information included in the hotel guest information notification.

When the two pieces of identifying information match, the check-in control unit 303 determines that the advance check-in regarding the reservation holder of the reservation to be processed (entry identified by the reservation number) has been successfully completed. In this case, the check-in control unit 303 writes “advance check-in completed” in the status field of the corresponding entry and stores the fact that the advance check-in has been completed in the database.

When the two pieces of identifying information do not match, the check-in control unit 303 determines that the advance check-in regarding the reservation holder of the reservation to be processed (entry identified by the reservation number) has failed. In this case, the check-in control unit 303 may not take any special action or may store the fact that the advance check-in has failed in the database.

In this way, the check-in control unit 303 sets the status of the advance check-in of the reservation holder to “advance check-in completed” when the hotel guest identifying information received from the terminal 40 and the reservation holder identifying information stored in the storage unit 304 match.

When the check-in control unit 303 receives an authentication request, the check-in control unit 303 extracts authentication information (biometric information or terminal ID) included in the authentication request.

When the check-in control unit 303 acquires biometric information (a face image) as authentication information, the check-in control unit 303 performs a biometric authentication (1-to-N authentication; N is a positive integer, the same applies hereinafter) using the acquired biometric information and biometric information stored in the reservation holder information database.

The check-in control unit 303 calculates a feature value from the face image included in a check-in request. Similarly, the check-in control unit 303 calculates a feature value from a face image stored in the reservation holder information database.

Note that since an existing technology can be used to process for generating the feature value by the check-in control unit 303, a detailed description thereof will be omitted. For example, the check-in control unit 303 extracts eyes, nose, mouth, and so on as feature points from the face image. After that, the check-in control unit 303 calculates the location of individual feature point and the distance between individual feature points as a feature value (generate a feature vector consisting of a plurality of feature values).

The check-in control unit 303 sets the feature value calculated from the authentication information as a target for matching and performs a matching processing between the feature value and the feature values calculated from the face images stored in the reservation holder information database. More specifically, the check-in control unit 303 sets the calculated feature value (feature vector) described above as the target for matching, and performs 1-to-N matching between the feature value and a plurality of feature values calculated from the reservation holder information database.

The check-in control unit 303 calculates a similarity between the feature value to be matched and each of the plurality of feature values on the registration side. For the individual similarity, the chi-squared distance, the Euclidean distance, and so on may be used. A longer distance represents a lower similarity, and a shorter distance represents a higher similarity.

The check-in control unit 303 determines that the matching processing has been successful when there exists a feature value whose similarity between the plurality of feature values calculated from the face image in the reservation holder information database and the feature value to be matched is greater than a predetermined value. The check-in control unit 303 determines that the matching processing has failed when the above-mentioned feature does not exist.

When the matching processing has failed, the check-in control unit 303 transmits a negative response indicating that the check-in control unit 303 has failed to check-in (authentication failure) to the check-in terminal 20.

When the matching processing has been successful, the check-in control unit 303 refers to the status field of the reservation holder with the highest similarity.

When “advance check-in completed” is set in the status field, the check-in control unit 303 determines that the user has successfully checked in. When “advance check-in completed” is not set in the status field, the check-in control unit 303 determines that the user has failed to check in.

When the check in failed, the check-in control unit 303 transmits a negative response indicating that fact (authentication failure) to the check-in terminal 20. When the user has successfully checked in, the check-in control unit 303 transmits a positive response indicating that fact (authentication success) to the check-in terminal 20. When the check-in control unit 303 notifies the check-in terminal 20 of authentication success (check-in success), the check-in control unit 303 transmits a positive response to that includes a guest room number, and so on to the check-in terminal 20.

Further, when the user has successfully checked in, the check-in control unit 303 sets the status of the corresponding user to “check-in completed”.

When the check-in control unit 303 has acquired a terminal ID as authentication information, the check-in control unit 303 determines whether or not the terminal ID is registered in the reservation holder information database.

When the terminal ID is not registered in the reservation holder information database, the check-in control unit 303 transmits a negative response indicating that the user has failed to check in to the check-in terminal 20.

When the terminal ID is registered in the reservation holder information database, the check-in control unit 303 refers to the status field of the corresponding entry.

When “advance check-in completed” is set in the status field, the check-in control unit 303 determines that the user has successfully checked in. When “advance check-in completed” is not set in the status field, the check-in control unit 303 determines that the user has failed to check in.

After that, the check-in control unit 303 processes in the same manner as when the biometric information is processed as authentication information.

The storage unit 304 is means for storing information necessary for the operation of the hotel server 10. The storage unit 304 stores reservation holder identifying information of the reservation holder, and so on. Further, the storage unit 304 stores the reservation holder identifying information of the reservation holder, the status of check-in, and the authentication information in association with each other.

[Reservation Server]

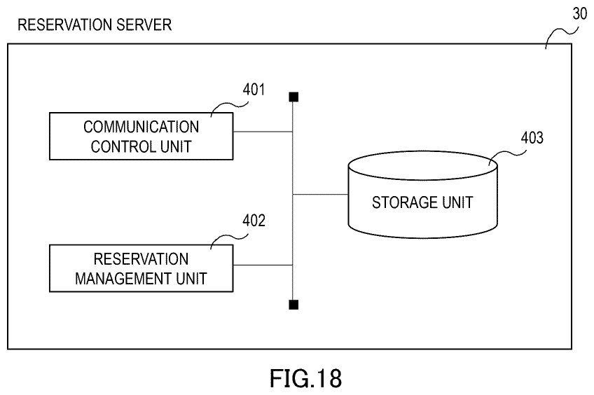

FIG. 18 is a diagram illustrating an example of a processing configuration (processing module) of the reservation server 30 according to the first example embodiment. Referring to FIG. 18, the reservation server 30 includes a communication control unit 401, a reservation management unit 402, and a storage unit 403.

The communication control unit 401 is means for controlling communication with other apparatuses. For example, the communication control unit 401 receives data (packets) from the terminal 40. In addition, the communication control unit 401 transmits data to the terminal 40. The communication control unit 401 gives data received from other apparatuses to other processing modules. The communication control unit 401 transmits data acquired from other processing modules to other apparatuses. In this way, other processing modules transmit and receive data to and from other apparatuses via the communication control unit 401. The communication control unit 401 includes a function as a receiving unit that receives data from other apparatuses and a function as a transmitting unit that transmits data to other apparatuses.

The reservation management unit 402 is means for managing a reservation of a hotel (guest room) by a user. The reservation management unit 402 basically performs the same operation as the reservation management unit 302 of the hotel server 10. The reservation management unit 402 acquires room availability and the like from affiliated hotel (the hotel server 10) in real time and provides the user with the information on an available room and information on a hotel (location, features, budget, and the like). Note that a reservation for a hotel made by the reservation server 30 is different from the purpose of the present application, so further description will be omitted.

The reservation management unit 402 receives a user information notification from the terminal 40 in the same manner as the reservation management unit 302 of the hotel server 10. When a reservation made by the user is completed, the reservation management unit 402 transmits a reservation completion notification to the terminal 40.

After the reservation management unit 402 transmits the reservation completion notification, the reservation management unit 402 transmits the user information notification (the notification that includes the user identifying information, the authentication information, and the like) received from the terminal 40 of the user and the reservation completion notification to the hotel server 10 (the hotel server 10 of the hotel reserved by the user).

The storage unit 403 is means for storing information necessary for the operation of the reservation server 30.

### [Check-In Terminal]

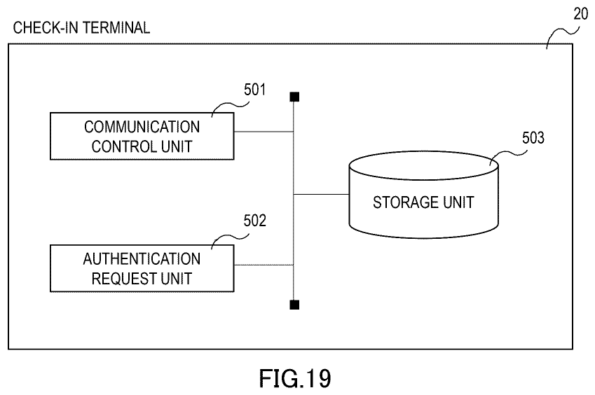

FIG. 19 is a diagram illustrating an example of a processing configuration (processing modules) of the check-in terminal 20 according to the first example embodiment. Referring to FIG. 19, the check-in terminal 20 includes a communication control unit 501, an authentication request unit 502, and a storage unit 503.

The communication control unit 501 is means for controlling communication with other apparatuses. For example, the communication control unit 501 receives data (packets) from the hotel server 10. In addition, the communication control unit 501 transmits data to the hotel server 10. The communication control unit 501 gives data received from other apparatuses to other processing modules. The communication control unit 501 transmits data acquired from other processing modules to other apparatuses. In this way, other processing modules transmit and receive data to and from other apparatuses via the communication control unit 501. The communication control unit 501 includes a function as a receiving unit that receives data from other apparatuses and a function as a transmitting unit that transmits data to other apparatuses.

The authentication request unit 502 is means for requesting the hotel server 10 to authenticate a user who wishes to proceed with a check-in procedure.

Here, the check-in terminal 20 supports three patterns of check-in: “check-in using biometric authentication” “check-in using code authentication” and “check-in using biometric or code authentication”.

A hotel manager or the like sets one of the above three patterns to the check-in terminal 20 in accordance with the policy of his/her hotel or the like. The authentication request unit 502 operates in accordance with the set pattern (mode of operation).

When the authentication request unit 502 detects a user in front of the authentication request unit 502 using a motion sensor or the like, the authentication request unit 502 acquires authentication information necessary for the check-in procedure. More specifically, the authentication request unit 502 displays the GUI corresponding to the above set mode of operation.

### <Check-In Using Biometric Authentication>

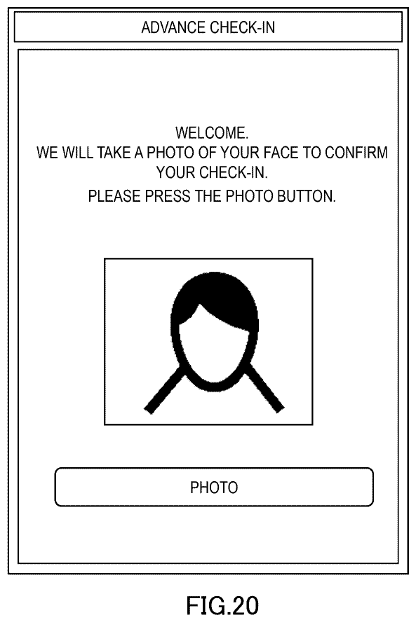

When the check-in using biometric authentication is supported, the authentication request unit 502 displays a GUI for acquiring biometric information. For example, the authentication request unit 502 acquires a face image of the user (hotel visitor) using the GUI as shown in FIG. 20.

### <Check-In Using Code Authentication>

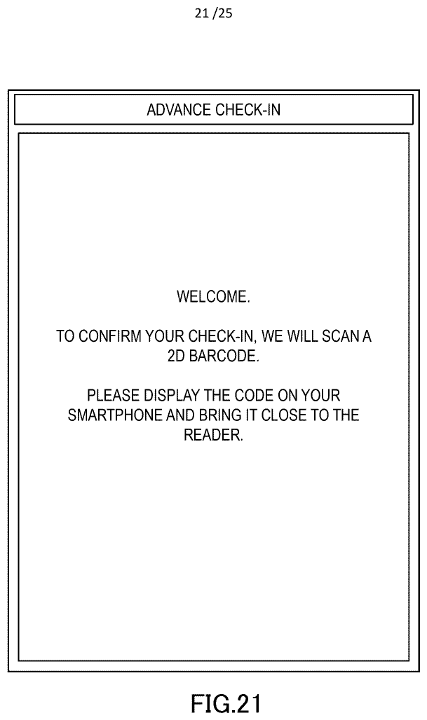

When the check-in using code authentication is supported, the authentication request unit 502 displays a GUI for acquiring a terminal ID. For example, the authentication request unit 502 acquires a two-dimensional barcode from the terminal 40 of the user (hotel visitor) using a GUI as shown in FIG. 21. The authentication request unit 502 decodes the two-dimensional barcode and retrieves the terminal ID.

### <Check-In Using Biometric Authentication or Code Authentication>

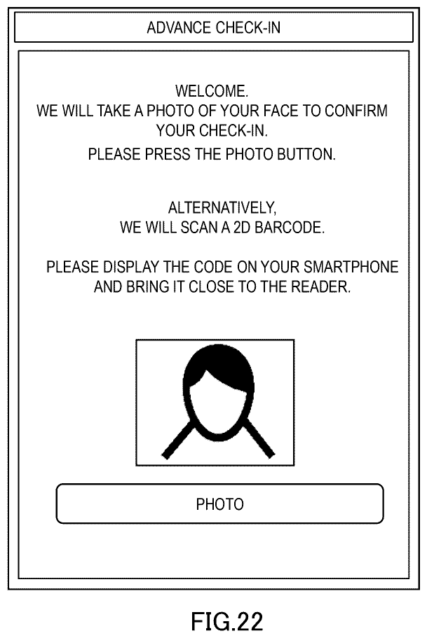

When both biometric authentication and code authentication are supported, the authentication request unit 502 displays a GUI to acquire either biometric information or a terminal ID. For example, the authentication request unit 502 acquires biometric information of the user (hotel visitor) or the terminal ID using a GUI such as the one shown in FIG. 22.

After the authentication request unit 502 acquires the authentication information (face image or terminal ID) using the GUI, the authentication request unit 502 transmits an authentication request that includes the acquired authentication information to the hotel server 10.

The authentication request unit 502 receives a response to the authentication request from the hotel server 10. When the authentication request unit 502 receives an authentication failure (failed check-in), the authentication request unit 502 notifies the user in front of the check-in terminal 20 to that effect.

When the user has successfully checked in, the authentication request unit 502 notifies the user in front of the check-in terminal 20 to that effect. At that time, the authentication request unit 502 notifies the user of the guest room number, and so on, determined by the hotel server 10. When the user has failed to check in, the authentication request unit 502 notifies the user to that effect.

The storage unit 503 is means for storing information necessary for the operation of the check-in terminal 20.

### [System Operation]

Next, operations of the information processing system according to the first example embodiment will be described.

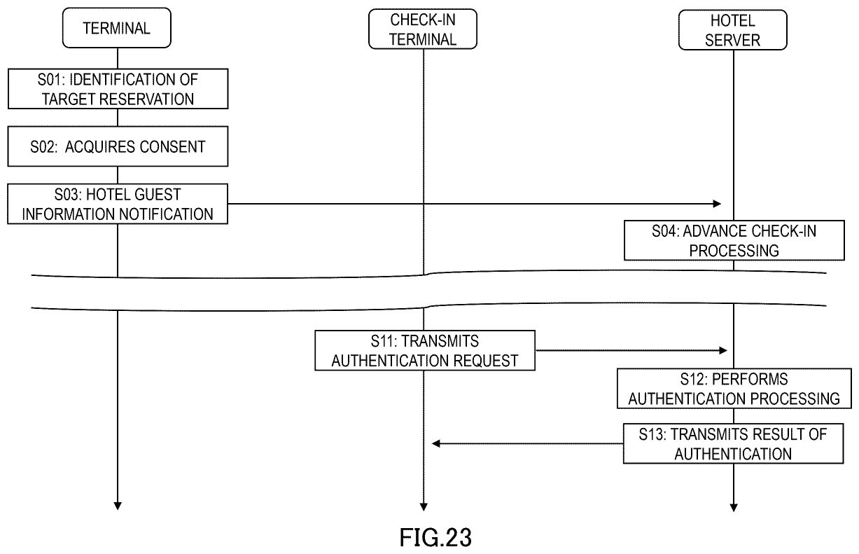

FIG. 23 is a sequence diagram illustrating an example of an operation in the information processing system according to the first example embodiment. Referring to FIG. 23, the operation of the information processing system according to the first example embodiment will be described.

The terminal 40 accesses the reserved hotel management database and identifies a reservation for which the start date of stay arrives on a predetermined day. In other words, the terminal 40 identifies the reservation that is subject to the advance check-in (identification of target reservation; step S01).

The terminal 40 acquires consent to provide information on hotel guest identifying information for the advance check-in (step S02).

When the user agrees to provide the hotel guest identifying information, the terminal 40 notifies the hotel guest information notification to the hotel server 10 (the hotel server 10 of the hotel where the user made the reservation) (step S03).

The hotel server 10 treats the advance check-in as completed when the reservation holder identifying information acquired in advance (information identifying the person who plans to stay at the hotel as acquired at the time of making a reservation for the hotel) and the hotel guest identifying information included in the received hotel guest information notification match (advance check-in processing; step S04). On the start date of stay, the user arrives at the hotel where he or she will stay. The user performs the check-in procedure using the check-in terminal 20.

The check-in terminal 20 acquires authentication information (face image, terminal ID) from the user in front of the check-in terminal 20 and transmits an authentication request including the authentication information to the hotel server 10 (step S11).

The hotel server 10 performs an authentication processing using the authentication information (step S12).

Specifically, the hotel server 10 determines that the authentication of the user (person to be authenticated) has been successful when the advance check-in of the reservation holder identified using the authentication information has been completed. In other words, the hotel server 10 determines that authentication of the target person who is about to perform the check-in procedure has been successful.

On the other hand, when the advance check-in of the target person has not been completed, the hotel server 10 determines that the authentication of the target person (the person to be authenticated) has failed.

The hotel server 10 transmits the result of authentication to the check-in terminal 20 (step S13).

The check-in terminal 20 outputs a message or the like in accordance with the received result of authentication (check-in success or check-in failure).

In this way, the check-in terminal 20 acquires the authentication information of the user who performs the check-in procedure and transmits the authentication request that includes the acquired authentication information to the hotel server 10. At that time, the check-in terminal 20 acquires the biometric information of the user who performs the check-in procedure or the terminal ID of the terminal 40 possessed by the user who performs the check-in procedure as the authentication information. The hotel server 10 identifies the status of the check-in of the reservation holder stored based on the received authentication information, and notifies the check-in terminal 20 that the check-in procedure of the user who performs the check-in procedure has been successful when the identified status is check-in completed.

As described above, in the information processing system according to the first example embodiment, the terminal 40 stores and manages reservations (reservation information) for a plurality of hotels. The hotel management application installed in the terminal 40 prompts the user to complete the “advance check-in procedure” a predetermined number of days before the start date of stay (check-in date) of the reserved hotel. Specifically, the terminal 40 asks the user to confirm that information on the hotel guest staying at the reserved hotel is his or her own information and to acquire his or her consent (user's consent) to provide the information of the hotel guest to the hotel where he or she will stay. When the user agrees to provide the information, the terminal 40 transmits the hotel guest identifying information to the hotel server 10. The hotel server 10 sets the status of the reservation holder to “advance check-in completed” when the reservation holder identifying information that identifies the reservation holder and the hotel guest identifying information transmitted via the advance check-in procedure match. The reservation holder can stay at the hotel without making a lodging registration card at the hotel. In this way, the reserved hotel information is consolidated into a single application (the hotel management application), and the user can complete the advance check-in simply by checking the screen displayed on the terminal 40 and pressing a button. As a result, tasks such as filling out a registration card at the hotel are no longer necessary, thereby improving convenience for the user.

In addition, even when the user makes a reservation for a hotel belonging to a different group, the user can manage each reservation by using the hotel management application. In other words, management of hotels of different groups (companies) and check-in preparation procedures can be performed with a single application. In other words, the user can prepare for check-in at a hotel belonging to different groups with a single application. In particular, a person staying in plurality of hotels on a business trip, and so on, only needs to check at least one application for the hotels while traveling, thereby improving the convenience for the user. Specifically, the terminal 40 allows the user to collectively manage information on the hotels reserved by the user using a display such as that shown in FIG. 12. At that time, the terminal 40 may display a star-shaped icon or the like so that the hotel that has completed the advance check-in procedure can be identified at a glance. Alternatively, the terminal 40 may display the scheduled date of check-in (start date of stay), the status of the smooth check-in availability of each hotel (compatible for biometric authentication, compatible for code authentication, compatible for biometric authentication and code authentication), and so on, for each hotel. The user can use a hotel more comfortably by using the hotel management application.

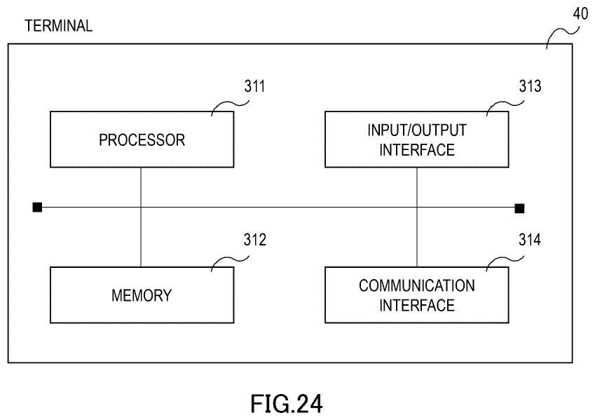

Next, a hardware configuration of an individual apparatus that constitutes the information processing system will be described. FIG. 24 is a diagram illustrating an example of a hardware configuration of the terminal 40.

The terminal 40 can be configured by an information processing apparatus (a so-called computer) and has a configuration illustrated as an example in FIG. 24. For example, the terminal 40 includes a processor 311, a memory 312, an input-output interface 313, a communication interface 314, etc. The components such as the processor 311 are connected to an internal bus, and so on so that these components can communicate with each other.

The hardware configuration of the hotel server 10 is not limited to the configuration illustrated in FIG. 24. The terminal 40 may include hardware not illustrated or may be configured without the input-output interface 313 if desired. In addition, the number of components, such as the number of processors 311, included in the terminal 40 is not limited to the example illustrated in FIG. 24. For example, a plurality of processors 311 may be included in the terminal 40.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), and so on. The memory 312 stores an OS program, an application program, and various kinds of data.

The input-output interface 313 is an interface for a display apparatus and an input apparatus not illustrated. For example, the display apparatus is a liquid crystal display and so on. For example, the input device is a device, such as a keyboard, a mouse or a touch panel which receives user operations.

The communication interface 314 is a circuit, a module, and so on for performing communication with other apparatuses. For example, the communication interface 314 includes a NIC (Network Interface Card) and so on.

The functions of the terminal 40 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

As is the case with the hotel server 10 and the reservation server 30, and so on, can each be configured by an information processing apparatus, and the basic hardware configuration of the hotel server 10 and the reservation server 30 is the same as that of the terminal 40. Thus, description of the basic hardware configuration of the hotel server 10 and the reservation server 30 will be omitted.

The terminal 40 includes a computer and can realize its functions by causing the computer to execute a program. In addition, the terminal 40 executes a terminal control method by using this program.

[Variations]

The configurations, operations, and so on of the information processing system according to the above example embodiments are examples and do not limit the present system configuration, and so on.

The above example embodiment describes that the check-in procedure can be performed using biometric authentication at the check-in terminal 20. When the hotel guest has performed the check-in procedure using biometric authentication, the hotel guest may also unlock the guest room using biometric authentication. In this case, a camera equipped on a door of the guest room acquires biometric information and transmits the biometric information to the hotel server 10. The hotel server 10 identifies the user by biometric authentication using the biometric information and unlocks the door of the guest room.

In the above example embodiment, the operation of the terminal 40 with respect to the advance check-in is described with reference to FIG. 9. The terminal 40 may display an estimated time of arrival at the hotel or may display an availability of a parking lot in the check-in procedure. Alternatively, the terminal 40 may acquire whether or not the user wishes to use the parking lot and notify the hotel server 10 of the acquired wish. When the hotel server 10 processes an authentication request from the check-in terminal 20, then, when the authentication is successful, the hotel server 10 may transmit to the check-in terminal 20 a guidance of the parking lot when the hotel guest wishes to use the parking lot. The check-in terminal 20 presents the acquired guidance of the parking lot to the user.

The above example embodiment describes that when the user identifying information and the reservation holder identifying information do not match, the terminal 40 does not notify the hotel server 10 of the information, or the like. However, when the two pieces of identifying information do not match, the terminal 40 may notify to the hotel server 10 that the reservation holder and the hotel guest are different. Specifically, the terminal 40 transmits a “change of hotel guest notification” that includes a reservation number to the hotel server 10. In this case, the hotel server 10 reflects the fact that the hotel guest has changed in the reservation holder information database.

When the hotel server 10 has failed in biometric authentication in response to the authentication request from the check-in terminal 20, the hotel server 10 may notify the check-in terminal 20 of the cause (factor) of the failure. Specifically, the hotel server 10 transmits to the check-in terminal 20 reasons such as the reservation of the hotel visitor is no registered in the reservation holder information database, or the advance check-in has not been completed, and so on. The check-in terminal 20 displays a message or the like in accordance with the notified cause (factor).

The check-in terminal 20 may guide the user who has failed to check in due to the fact that the reservation of the hotel visitor is not registered in the reservation holder information database, to go to a manned front desk. Alternatively, the check-in terminal 20 may guide the user who has failed to check in due to the fact that the advance check-in has not been completed, to fill in his or her name, and so on, and to complete registration of the stay.

The above example embodiment describes that the terminal 40 represents the status of the advance check-in by using a figure. However, the terminal 40 may represent the status of the advance check-in by any method and notify the user of the status of the advance check-in. For example, the terminal 40 may use a different type of figure, or may use a letter or symbol. Alternatively, the terminal 40 may take action such as blinking the figure.

The above example embodiment describes a case in which the reservation holder information database is configured within the hotel server 10, but the database may be established on an external database server or the like. In other words, some functions of the hotel server 10 may be implemented in another apparatus. More specifically, the “reservation management unit (reservation management means)”, “check-in control unit (check-in control means)”, and so on described above may be implemented in any apparatus included in that includes the system.

The above example embodiment describes a case in which the hotel server 10 stores the biometric information of the user (the person who plans to stay at the hotel). However, an authentication server (not shown) different from the hotel server 10 may retain the biometric information of the user (authentication information). In this case, the authentication server may store biometric information for each hotel reservation holder and perform biometric authentication based on a request from the hotel server 10. The authentication server transmits an ID that is uniquely determined from the hotel and the user to the hotel server 10 that has sent the authentication request. The hotel server 10 may acquire the reservation holder identifying information, and so on, of a target for authentication (a person to be authenticated) based on the ID.

The above example embodiment describes that the terminal ID of the terminal 40 is used as the information (authentication code) used for the code authentication. However, the authentication code can be any information, not limited to the terminal ID. In addition, instead of the user inputting the authentication code, the hotel server 10 may generate the authentication code and transmit a two-dimensional barcode converted from the generated authentication code to the terminal 40. In this case, the hotel server 10 treats a hash value or the like of the reservation number as the authentication code and registers the authentication code in the reservation holder information database. The hotel server 10 converts the authentication code into a two-dimensional bar code and transmits the two-dimensional bar code to the terminal 40. The user displays the two-dimensional bar code acquired from the hotel server 10 by operating the terminal 40 during the check-in procedure. The check-in terminal 20 may acquire the two-dimensional barcode, acquire an authentication code from the acquired two-dimensional barcode, and transmit the authentication code to the hotel server 10.

The above example embodiment describes that the hotel management application sets the status of the corresponding reservation to “advance check-in completed” at the timing when the hotel guest information notification is transmitted from the terminal 40 to the hotel server 10. However, the hotel management application may set the status of the corresponding reservation to “advance check-in completed” after the hotel management application has received a notification that the hotel server 10 successfully processed the above hotel guest information notification from the hotel server 10. In this case, the hotel server 10 may transmit a positive response indicating that the hotel server 10 has successfully processed the hotel guest information notification to the terminal 40 after the hotel server 10 has received the guest information notification and has stored the fact that the advance check-in has completed in the reservation information database. Note that when the hotel server 10 fails to process the hotel guest information notification, the hotel server 10 transmits a negative response to that effect to the terminal 40.

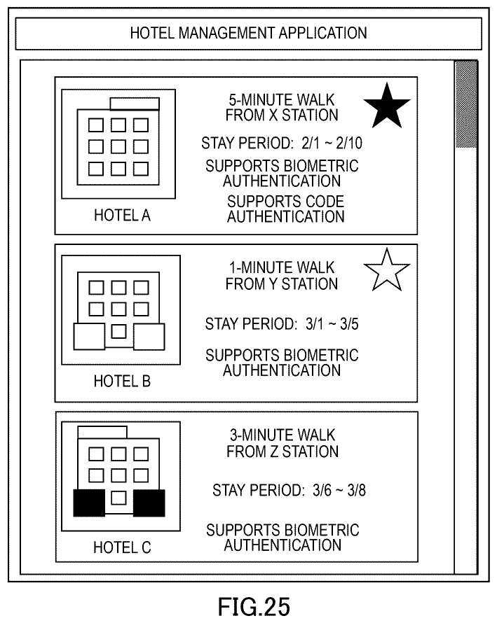

The above example embodiment describes a case in which the hotel management application manages two statuses, “advance check-in completed” and “advance check-in not completed”, as the status of the advance check-in. However, the hotel management application may manage the status of the “advance check-in not completed” in more detail. Specifically, the hotel management application may manage the status before the timing of the advance check-in arrives (before the advance check-in) and the status in which the timing of the advance check-in arrived but the advance check-in has not been performed (the advance check-in not performed). The hotel management application manages the status of the advance check-in procedure as “before the advance check-in”, which is the status before the advance check-in procedure is prompted to the user using the display shown in FIG. 9. In addition, when the hotel management application prompts the user to perform the advance check-in procedure, but the user does not perform the advance check-in procedure (when the cancel button in FIG. 9 is pressed), the hotel management application manages the status of the advance check-in as “advance check-in not performed”. The hotel management application may present the above three statuses of the advance check-in to the user by distinguishing the three statuses by the presence or absence of the display of a figure or by the color of the figure, and so on. For example, as in Hotel C in FIG. 25, the hotel management application (the reserved hotel management unit 205) represents the status before the advance check-in by not displaying the star-shaped figure. In addition, as in Hotel A in FIG. 25, the hotel management application represents the status of the “advance check-in completed” by a black star figure, and as in Hotel B, the hotel management application represents the status of the “advance check-in not completed” by a white star figure.

The above example embodiment describes a case in which the face image is transmitted from the terminal 40 to the hotel server 10 as biometric information. However, a feature value generated from the face image may be transmitted from the terminal 40 to the hotel server 10 as biometric information. Alternatively, the reservation holder information database of the hotel server 10 may store a feature value as biometric information of the user (authentication information) instead of the face image.

While the data exchange between the terminal 40, the hotel server 10, and the reservation server 30 is not limited to any particular mode, data exchanged between these apparatuses may be encrypted. It is desirable that the biometric information and so on are transmitted and received between these apparatuses and encrypted data is transmitted and received in order to properly protect this information.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to information processing systems for making reservations for hotels and the like.

A part or the entirety of the example embodiments described above may be described as in the following supplementary notes, but is not limited to the followings.

### Supplementary Note 1

A system, including:
a hotel server managed by a hotel; and
a terminal possessed by a user,
wherein the system terminal further includes:
a storage unit that stores reservation information of the hotel including
a start date of stay and reservation holder identifying information that identifies a reservation holder of the hotel in association with each other; and
an advance check-in control unit that asks the user to agree to provide the reservation holder identifying information to the hotel server a predetermined period before the start date of stay, and transmits the reservation holder identifying information to the hotel server as hotel guest identifying information that identifies a hotel guest staying at the hotel when the user agrees to provide the reservation holder identifying information.

### Supplementary Note 2

The system according to supplementary note 1, wherein the hotel server stores the reservation holder identifying information of the reservation holder, and sets a status of a check-in of the reservation holder to advance check-in completed when the hotel guest identifying information received from the terminal and the stored reservation holder identifying information match.

### Supplementary Note 3

The system according to supplementary note 2, wherein the hotel server stores the reservation holder identifying information of the reservation holder, the status of the check-in and authentication information in association with each other, and
wherein the system further includes a check-in terminal for performing a check-in procedure at the hotel, and
wherein the check-in terminal acquires the authentication information of a user who performs the check-in procedure and transmits an authentication request including the acquired authentication information to the hotel server, and
wherein the hotel server identifies the status of the check-in of the reservation holder stored based on the received authentication information, and notifies the check-in terminal that the check-in procedure of the user who performs the check-in procedure has been successful when the identified status is check-in completed.

### Supplementary Note 4

The system according to supplementary note 3, wherein the check-in terminal acquires biometric information of the user who performs the check-in procedure or a terminal ID of the terminal possessed by the user who performs the check-in procedure as the authentication information

### Supplementary Note 5

The system according to supplementary note 4, wherein the biometric information is a face image or feature value extracted from the face image.

### Supplementary Note 6

The system according to any one of supplementary notes 1 to 5, wherein the storage unit stores user identifying information that identifies the user, and
wherein the advance check-in control unit asks the user to agree to provide the reservation holder identifying information to the hotel server when the user identifying information and the reservation holder identifying information match.

### Supplementary Note 7

The system according to any one of supplementary notes 1 to 6, wherein the terminal further includes a reserved hotel management unit that displays information related to a reservation of the hotel.

### Supplementary Note 8

The system according to supplementary note 7, wherein the storage unit stores a status of an advance check-in corresponding to a reservation for which the hotel guest identifying information has been transmitted, and wherein the reserved hotel management unit displays the status of the advance check-in when displaying the information related to the reservation of the hotel.

### Supplementary Note 9

The system according to supplementary note 8, wherein the reserved hotel management unit displays the status of the advance check-in by changing a color of a figure.

### Supplementary Note 10

A terminal, including:
a storage unit that stores reservation information of a hotel including a start date of stay and reservation holder identifying information that identifies a reservation holder of the hotel in association with each other; and
an advance check-in control unit that asks the user to agree to provide the reservation holder identifying information to a hotel server a predetermined period before the start date of stay, and transmits the reservation holder identifying information to the hotel server as hotel guest identifying information that identifies a hotel guest staying at the hotel when the user agrees to provide the reservation holder identifying information.

### Supplementary Note 11

A control method of a terminal, the control method including:
storing reservation information of a hotel including a start date of stay and reservation holder identifying information that identifies a reservation holder of the hotel in association with each other; and
asking the user to agree to provide the reservation holder identifying information to a hotel server a predetermined period before the start date of stay, and transmitting the reservation holder identifying information to the hotel server as hotel guest identifying information that identifies a hotel guest staying at the hotel when the user agrees to provide the reservation holder identifying information.

### Supplementary Note 12

A computer-readable storage medium storing a program causing a computer mounted on an authentication terminal to perform processing for:
storing reservation information of a hotel including a start date of stay and reservation holder identifying information that identifies a reservation holder of the hotel in association with each other; and
asking the user to agree to provide the reservation holder identifying information to a hotel server a predetermined period before the start date of stay, and transmitting the reservation holder identifying information to the hotel server as hotel guest identifying information that identifies a hotel guest staying at the hotel when the user agrees to provide the reservation holder identifying information.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and sprit of the present invention. That is, the present invention of course includes various variations and modifications that could be made by those skilled in the art in accordance with the overall disclosure including the claims and the technical concept.

### REFERENCE SIGNS LIST

10 hotel server
20 check-in terminal
30 reservation server
40 terminal
101 hotel server
102 terminal
111 storage unit
112 advance check-in control unit
201 communication control unit
202 initial registration control unit
203 hotel reservation control unit
204 advance check-in control unit
205 reserved hotel management unit
206 storage unit
301 communication control unit
302 reservation management unit
303 check-in control unit
304 storage unit
311 processor
312 memory
313 input/output interface
314 communication interface
401 communication control unit
402 reservation management unit
403 storage unit
501 communication control unit
502 authentication request unit
503 storage unit

What is claimed is:

1. A system, comprising:
a hotel server managed by a hotel; and
a terminal possessed by a user,
wherein the terminal comprises:
at least one memory storing a set of instructions; and
at least one processor configured to execute the set of instructions to:
store reservation information of the hotel including a start date of stay and reservation holder identifying information that identifies a reservation holder of the hotel in association with each other; and
ask the user to agree to provide the reservation holder identifying information to the hotel server a predetermined period before the start date of stay, and transmit the reservation holder identifying information to the hotel server as hotel guest identifying information that identifies a hotel guest staying at the hotel when the user agrees to provide the reservation holder identifying information.

2. The system according to claim 1, wherein the hotel server stores the reservation holder identifying information of the reservation holder, and sets a status of a check-in of the reservation holder to advance check-in completed when the hotel guest identifying information received from the terminal and the stored reservation holder identifying information match.

3. The system according to claim 2, wherein the hotel server stores the reservation holder identifying information of the reservation holder, the status of the check-in and authentication information in association with each other, and
wherein the system further comprises a check-in terminal for performing a check-in procedure at the hotel, and
wherein the check-in terminal acquires the authentication information of a user who performs the check-in procedure and transmits an authentication request including the acquired authentication information to the hotel server, and
wherein the hotel server identifies the status of the check-in of the reservation holder stored based on the received authentication information, and notifies the check-in terminal that the check-in procedure of the user who performs the check-in procedure has been successful when the identified status is check-in completed.

4. The system according to claim 3, wherein the check-in terminal acquires biometric information of the user who performs the check-in procedure or a terminal ID of the terminal possessed by the user who performs the check-in procedure as the authentication information

5. The system according to claim 4, wherein the biometric information is a face image or feature value extracted from the face image.

6. The system according to claim 1, wherein
the at least one processor is further configured to execute the set of instructions to:
stores user identifying information that identifies the user, and
wherein
the at least one processor is further configured to execute the set of instructions to:
ask the user to agree to provide the reservation holder identifying information to the hotel server when the user identifying information and the reservation holder identifying information match.

7. The system according to claim 1, wherein
the at least one processor is further configured to execute the set of instructions to:
display information related to a reservation of the hotel.

8. The system according to claim 7, wherein
the at least one processor is further configured to execute the set of instructions to:
store a status of an advance check-in corresponding to a reservation for which the hotel guest identifying information has been transmitted, and
wherein
the at least one processor is further configured to execute the set of instructions to:
display the status of the advance check-in when displaying the information related to the reservation of the hotel.

9. The system according to claim 8, wherein
the at least one processor is further configured to execute the set of instructions to:
display the status of the advance check-in by changing a color of a figure.

10. A terminal, comprising:
at least one memory storing a set of instructions; and
at least one processor configured to execute the set of instructions to:
store reservation information of a hotel including a start date of stay and reservation holder identifying information that identifies a reservation holder of the hotel in association with each other; and
ask the user to agree to provide the reservation holder identifying information to a hotel server a predetermined period before the start date of stay, and transmit the reservation holder identifying information to the hotel server as hotel guest identifying information that identifies a hotel guest staying at the hotel when the user agrees to provide the reservation holder identifying information.

11. A control method of a terminal, the control method comprising:
storing reservation information of a hotel including a start date of stay and reservation holder identifying information that identifies a reservation holder of the hotel in association with each other; and
asking the user to agree to provide the reservation holder identifying information to a hotel server a predetermined period before the start date of stay, and transmitting the reservation holder identifying information to the hotel server as hotel guest identifying information that identifies a hotel guest staying at the hotel when the user agrees to provide the reservation holder identifying information.

12. (canceled)
